(19) United States
(12) Patent Application Publication
(10) Pub. No.: US 2015/0327039 A1
(43) Pub. Date: Nov. 12, 2015

(54) METHOD AND APPARATUS FOR PROVIDING EVENT INVESTIGATION THROUGH WITNESS DEVICES

(71) Applicant: Verizon Patent and Licensing Inc., Arlington, VA (US)

(72) Inventor: Pankaj Kumar JAIN, Ashburn, VA (US)

(73) Assignee: Verizon Patent and Licensing Inc., Arlington, VA (US)

(21) Appl. No.: 14/271,994

(22) Filed: May 7, 2014

(51) Int. Cl. H04W 4/22; H04M 1/725; H04W 76/00

(52) U.S. Cl. CPC H04W 4/22; H04W 76/007; H04M 1/72536

(57) ABSTRACT

An approach is provided for corroborating with the investigation of an emergency event. An event processor receives an event data corresponding to an event from a mobile device, and the location of the mobile device is determined. Participating device(s) within the vicinity of the emergency event, as defined by the location of the mobile device, are selected and provided with the option to submit information regarding the event to a database used by authorities.

### BACKGROUND INFORMATION

Modern telecommunications services, particularly wireless mobile communication devices, can be essential public safety tools used by authorities in emergency response and investigation. Traditionally, the investigation of an event requires documentation and/or eyewitnesses to prove the event. Conventionally, local authorities reach out door-to-door, use security devices or transit log history to be able to reach a conclusion of what might have happened, to gather information, and to find witnesses. This approach consumes a lot of the local authorities' time and, in some cases, information is missed, lost, or is not reliable by the time the authorities obtain the information. Therefore, there is a need for an approach to effectively and efficiently collect emergency event information, as the emergency event happens or immediately after the emergency event happened.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing event investigation through witness devices, according to an exemplary embodiment;

FIG. 2 is a diagram of a platform for investigating an event, according to various embodiments;

FIG. 3 is a flowchart of a process for instructing a witness device to submit information regarding the emergency event, according to one embodiment;

FIG. 4 is a flowchart of a process for providing event investigation through witness devices, according to one embodiment;

FIG. 5 is a flowchart of a process for submitting information regarding the emergency event, according to an exemplary embodiment;

FIG. 6 is a flowchart of the process for enabling the acquisition of emergency event information from one or more participating devices, according to an exemplary embodiment;

FIG. 7 is a diagram depicting an interaction between towers, computing devices, public-safety answering point, and participating devices in various locations, according to one embodiment;

FIGS. 8A and 8B are diagrams of a user interface for receiving an emergency event notification and approving participation in assisting with the investigation of the emergency event, according to various embodiments;

FIGS. 9A and 9B are diagrams of a user interface for submitting information about an emergency event and collecting more specific information about the emergency event according to various embodiments;

FIG. 10 is a diagram of a computer system for implementing various exemplary embodiments; and

FIG. 11 is a diagram of a chip set for implementing an embodiment of the invention.

### DESCRIPTION OF THE PREFERRED EMBODIMENT

A preferred method, apparatus, and system for providing event investigation through witness devices are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a mobile device, it is contemplated that these embodiments have applicability to any device capable of communicating over a network using voice and non-voice technologies. Such voice-based call can be traditional plain-old-telephone service (POTS) calls or packetized voice calls (e.g., VoIP). These communication sessions can occur concurrently during an emergency call.

Although various exemplary embodiments are described with respect to a computing or user device that is a non-stationary device, it is contemplated that the approaches of the various embodiments are also applicable to stationary devices. Examples of stationary devices include customer premise equipment (CPE), set-top boxes, desktop computers, wired telephone stations, security cameras, motion detectors, etc. Examples of non-stationary devices include laptop computers, mobile phones, wireless portable devices (e.g., personal digital assistants (PDAs), tablets, etc.

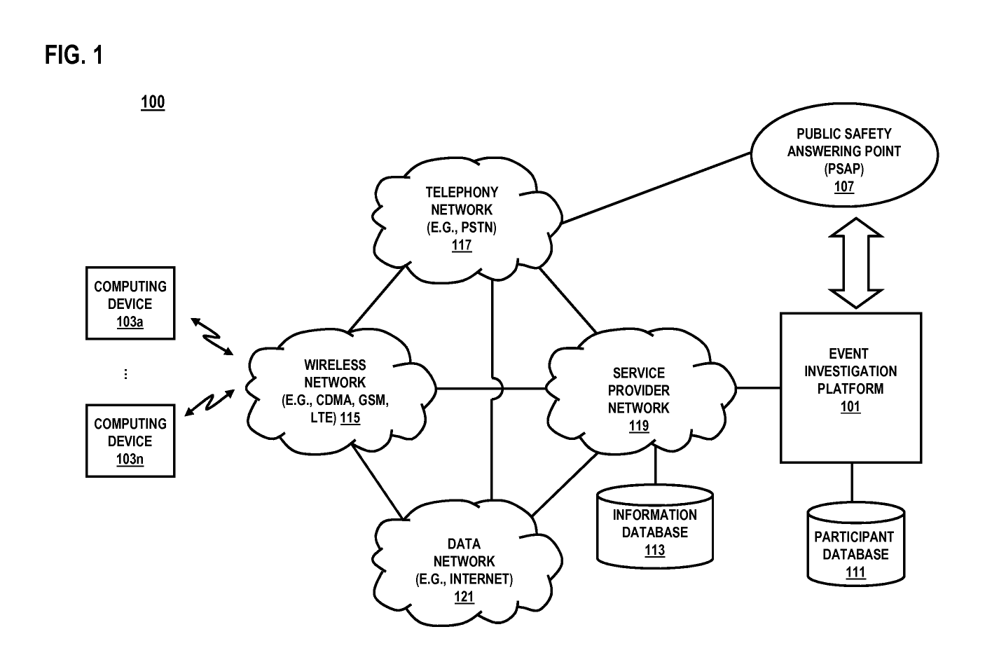

FIG. 1 is a diagram of a system capable of providing event investigation through witness devices according to an exemplary embodiment. For example, in the case of the kidnapping of a minor, fast and accurate information is necessary for quick discovery of the child and perpetrators. Oftentimes parents of the child do not see the person who took their child, but other persons at the site of the kidnapping might have information about the kidnappers and child. The difficulty is then collecting information and/or finding potential witnesses which, more often than not, do not recall details or were not in position to see the event. Immediate documentation by potential witnesses and receipt of that information by authorities would result in a much higher likelihood of discovering kidnapper identities and whereabouts of the child. As well as, place authorities in a position to reduce wasted time.

Emergency calls, (e.g., “911” calls), are one example of a type of call that could trigger the process of obtaining information of an emergency event. Currently, in an emergency situation, a person calls a public-safety answering point (PSAP) via 911 or some other emergency access number. Generally, the process of obtaining information about the emergency event that the person is calling about would start after the team dispatched by the PSAP to address the event. In some cases, authorities conducting an investigation of the event may show up at the event at a much later time than the initial responders or the occurrence of the event. These investigators may then need to find witnesses or discover information as soon as possible in order to be able to resolve the event, to discover what transpired, to later prosecute a perpetrator, or a combination thereof.

Should the PSAP receiving the emergency call be equipped according to the embodiments described herein, the embodiments of the method, apparatus, and system described herein can allow immediate collection of information regarding the event as the event is occurring, or even prior to the event. In some cases, for example, if information or evidence cannot be collected immediately or within a relatively short period of time, the information may disappear with potential witnesses, or may not be as reliable. Additionally, depending on the nature of the emergency, this delay (which may only be a few minutes) can be critical, and may be a matter of life or death.

To address this delay problem, the approach of system 100, according to certain embodiments, can obtain information from participant devices within the vicinity of an event. In this manner, because of their proximity to the computing device user which notified emergency services, these individuals may be able to collect important information for the investigation of the event, or even be able to assist the user of the computing device prior to the event investigators. The approach, according to certain embodiments, disseminates a notification about the event to participating users within a predetermined proximity of the emergency notifying device so that the participating users can collect information about the event for authorities. The users may be selected according to one or more selection criteria, such as proximity, time of the day, previous participation, and/or any other such criteria. For example, a notification would more likely be sent to a participating user with a history of efficiently submitting reliable information about events, who, when notified, may be able to provide more information than a user that has never participated before.

Although the various embodiments are described in relation to the emergency event, it is contemplated that approached in the embodiments also have applicability to collecting witness information about non-emergency events.

As previously mentioned, FIG. 1 is a diagram of a system capable of providing event investigation through witness devices according to an exemplary embodiment. For the purposes of explanation, system 100 is shown to include one or more computing devices 103a-103n (e.g., mobile device, smart phone, tablet, netbook, laptop, sensor, security device, set-top box, or any communications enabled computing device). It is contemplated that computing devices 103a-103n may be the device of a user in the midst of the emergency event and/or may be a device of a participating user or participating device that collects information regarding the emergency event. An event investigation platform 103 is configured to communicate with a public safety answer point (PSAP) 107 to collect and share emergency event information. The emergency event information collected from participant user may be stored in participant database 111. The event investigation platform 101 processes the emergency event information to perform various executions, including for example: (1) receiving notification of an event to initiate an information collection procedure to obtain information related to the event from one or more devices 103a-103n; (2) determining location information associated with the event; (3) identifying one or more computing devices 103a-103n within proximity of the event based on the location information; (4) determining whether the identified one or more computing devices 103a-103n are participating devices; (5) generating a message to instruct one or more of the participating devices to collect information related to the event.

By way of example, in the case of computing devices 103a-103n which are mobile devices, identifying the nearest participating devices of users can be enhanced by including geographical or spatial information (for determining local information) in the telephone call set-up as well. A constellation of global positioning system (GPS) satellites can communicate with the mobile devices 103a-103n to provide such location information. This may prove useful in determining proximity to emergency events that may be occurring in multi-story high-rises or underground where only having longitude-latitude coordinates may not be enough to determine true distance from the emergency event.

By way of example, one or more computing devices 103a-103n may be configured to determine corresponding spatial positioning information through conventional satellite positioning system (SPS) technology, such as GPS technology; however, any suitable navigational or location determination technology may be utilized, such as advanced forward link trilateration (A-FLT), assisted-GPS (A-GPS), enhanced cellular identification (CELL-ID), wireless area network (WLAN) positioning, etc. SPS technology utilizes a constellation of satellites that transmit signals to receivers (not shown) of, for example, one or more computing devices 103a-103n, so that the receivers may determine corresponding spatial positions (or locations), directions, and/or timing for computing devices 103a-103n. Furthermore, computing devices 103a-103n may include information capturing tools such as integrated camera devices, audio recorders, video recorders, GPS, accelerometers, compasses, gyros, proximity sensors, barometers, terminals, any other tools for measuring events, or any combination of tools, which will assist in the collection of information.

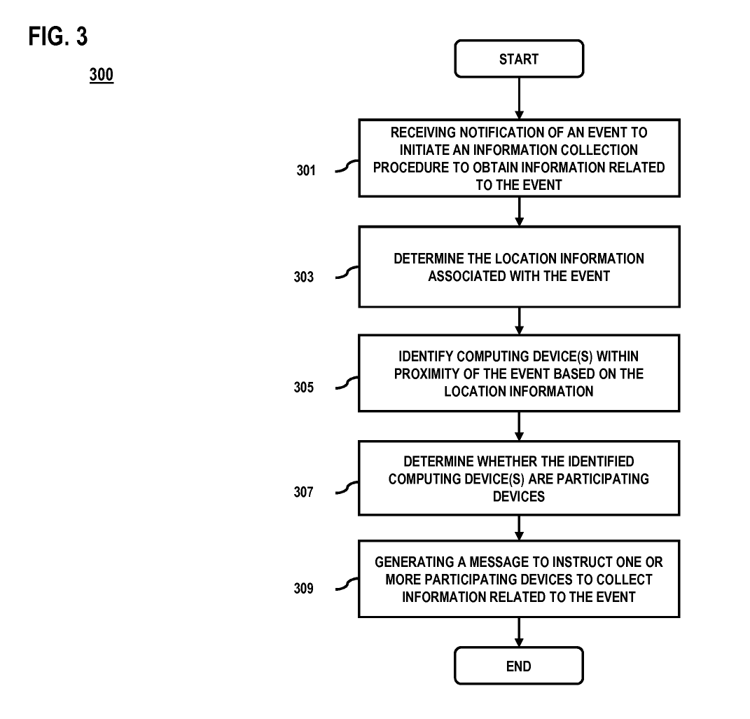

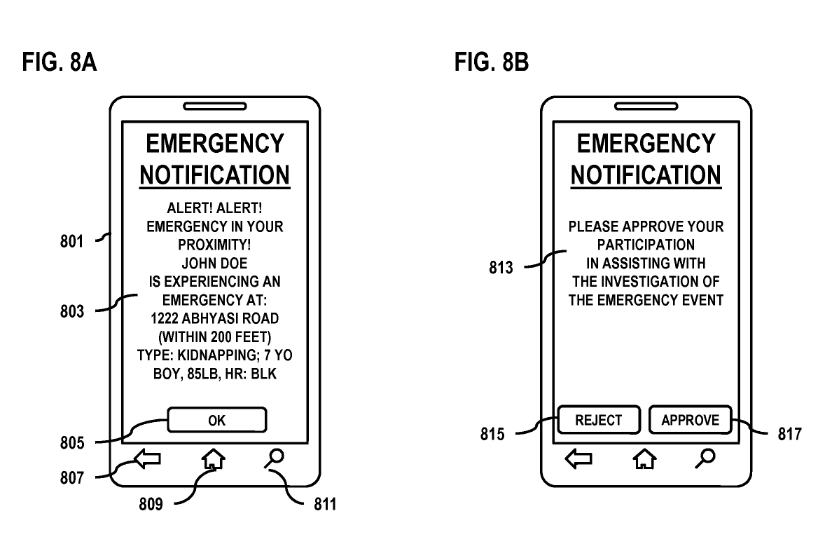

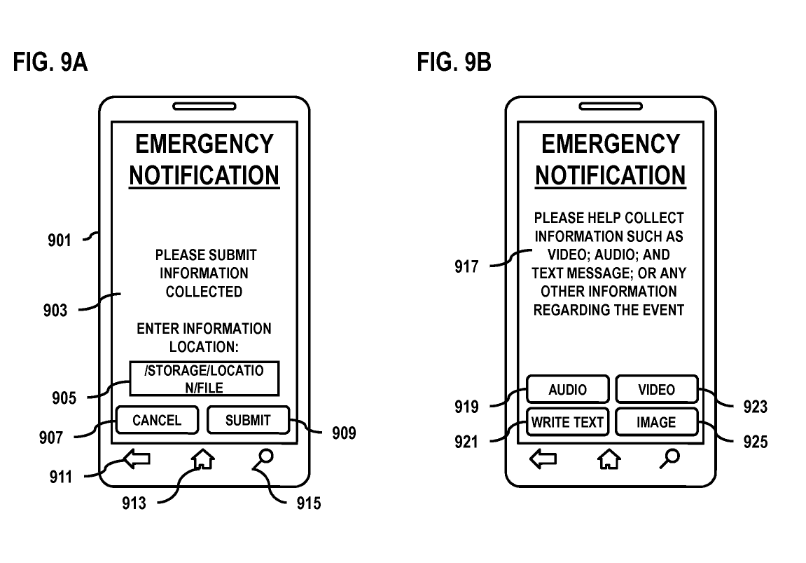

Public Safety Answering Point (PSAP) 107 operates in conjunction with an event investigation platform 101 to provide a data collection capability. The event investigation platform 101 can determine which devices are within a predetermined proximity to a signaling device, and issue an alert to devices in proximity with the signaling device. A participant database 111 is maintained to store information about which devices and users are participating in the emergency notification service and to manage storage of metadata about the event (e.g. time, location, device type, etc.). The information database 113, on the other hand, stores specific information/data collected from the emergency event and submitted by the participating user (e.g. text, audio, images, video, motion information, distance/range information, etc.). Additionally, in one embodiment, users who may be willing to participate in this service are trained medical personnel, police officers, fire fighters, volunteers, etc. For example, with this emergency notification service, an off-duty officer, may be able to reach the person in distress much more rapidly than emergency responders because the officer is nearby. In this example, the off-duty officer would be able to assist in resolving the emergency and/or in collecting information about the event as the event happens or immediately after the event. The processes associated with this emergency notification service are more fully detailed below with respect to FIGS. 3-6. The notification message, by way of example, can be presented on a graphical user interface (GUI) of the computing device 103a-103n, as depicted in FIGS. 8 and 9.

In system 100, according to certain embodiments, one or more networks, such as data network 121, service provider network 119, telephony network 117, and/or wireless network 115, are provided to handle various communication sessions, voice communications as well as non-voice communications. Networks 115-121 may be any suitable wireline and/or wireless network. For example, telephony network 117 may include a circuit-switched network, such as the public switched telephone network (PSTN), an integrated services digital network (ISDN), a private branch exchange (PBX), or other like network. As shown, information database 113, according to certain embodiments, stores user and device locations and preferences. Thus, if a user initiates an emergency signal, for instance, the service provider network 119 can obtain the location of the user through the participating device. This advantageously, may be used to direct the participating users to the location from which emergency event information can be collected. The service provider can operate anyone of the networks 115-121, or a combination thereof. Additionally, in certain embodiments, a signal can be forwarded to, or received from the computing devices via Bluetooth®, wireless fidelity (WiFi), or other compatible technology.

Wireless network 115 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), WiFi, long term evolution (LTE), satellite, and the like. Meanwhile, data network 121 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Additionally, the networks 121 and 119 may encompass terrestrial broadcasting networks, provider specific networks (e.g., a Verizon® FiOS® network, a TiVo® network, etc.), and the like. Further, the service provider can be an internet protocol television (IPTV) service provider, which offers subscribers various video services ranging from multi-channel video programming that mimics traditional broadcast television, to true video-on-demand (VOD) programming. In one embodiment, service provider network 119 integrates the television medium with that of the telecommunications, computing, and media environments, thereby broadening the scope of devices and sources available to individuals for obtaining media content. In this manner, users, via user equipment (e.g., computing devices 103a-103n) can receive and/or transmit media content accessible over the data network 121. Although the user equipment is described with respect to a mobile phone, it is contemplated that various embodiments have applicability to any device capable of processing audio and/or video streams, text, photo, calls, etc. It is contemplated that media content broadly includes any audio-visual content (e.g., broadcast television programs, VOD programs, pay-per-view programs, IPTV feeds, digital video disc (DVD) related content, etc.), pre-recorded media content, data communication services content, Internet services content (streamed audio, video, or pictographic media), and/or any other equivalent media form.

Although depicted as separate entities, networks 115-121 may be completely or partially contained within one another, or may embody one or more of the aforementioned infrastructures. For instance, service provider network 119 may embody circuit-switched and/or packet-switched networks that include facilities to provide for transport of circuit-switched and/or packet-based communications. It is further contemplated that networks 115-121 may include components and facilities to provide for signaling and/or bearer communications between the various components or facilities of system 100. In this manner, networks 115-121 may embody or include portions of a signaling system 7 (SS7) network, or other suitable infrastructure to support control and signaling functions. As such, the conjunction of networks 115-121 may be adapted to facilitate the remote control and tracking services of system 100.

Under the scenario of FIG. 1, event investigation platform 101 is maintained by a service provider, and thus, can interact with the PSAP 107 via the service provider network 119. The event investigation platform 101 may assist with establishing a communication session between a participating device and the PSAP 107 to enable the gathering of information about the emergency situation. The PSAP 107, thus, may more effectively attend to the emergency call, and the investigation authorities may more efficiently have access to information about the event. While specific reference will be made hereto, it is contemplated that system 100 may embody many forms and include multiple and/or alternative components and facilities. In one embodiment, the platform 101 can be deployed as part of the PSAP 107.

Although the approach for obtaining emergency event information services is described with respect to an emergency call originating from a mobile device, it is contemplated that this approach is applicable to any device capable of supporting a voice call and a non-voice form of communication—e.g., mobile device or any computing device 103a-103n. Computing device 103a may be any suitable computing device capable of receiving the notification message from the platform 101; moreover, the computing device 103n can be a voice over internet protocol (VoIP) phone, skinny client control protocol (SCCP) phone, session initiation protocol (SIP) phone, IP phone, personal computer, softphone, workstation, terminal, server, etc.

As mentioned, one type of voice call that a mobile device (e.g., mobile device 103a) may initiate involves an emergency call to a 911 operator within PSAP 107. For this purpose, the wireless network 115 may provide services and features that allow it to identify and locate the caller and the participant who collects information regarding the event. In particular, the wireless network 115 includes an anchoring service that can identify the location of the caller and, based on that information, locate a local 911 operator to handle the call. Consequently, the anchoring service can route the call to the local 911 operator and provide the operator both the identity of the caller and the location of the caller. It is also contemplated that the identity of the participant who collects information about the event from the computing device 103a-103n can be provided, as explained in more details in FIGS. 8 and 9. Any of the various anchoring services for wired, wireless, and voice over IP (VoIP) networks are contemplated.

Based on the determination of the local 911 operator, the wireless network 115 can communicate through telephony network 117 to the local Public Safety Answering Point 107. At the PSAP 107, operators have access to platform 101 that allows each operator to handle voice calls and non-voice messaging applications. Furthermore, if the caller subscribes to a content delivery service (e.g., Fiber-Optic Television (FIOS)), in addition to the call being routed to the PSAP, emergency notification can also be broadcast through the data network 121 (e.g. Internet).

According to one embodiment, the platform 101 allows the 911 operator at the PSAP 107 to communicate with a caller and/or a participant utilizing either a voice call, a non-voice messaging method, any other signaling method, or any combination thereof. A 911 caller, e.g., using device 103a may, for example, be within an immediate vicinity of other devices 103b-103n. The platform 101 can alert these devices 103b-103n, if the platform 101 determines that such devices 103b-103n are located within a predetermined vicinity of mobile device 103a. In this manner, the user of device 103n can rush to the calling party's aid or collect information about the event and submit the information to event investigation platform 101. In addition to supporting the traditional scenario in which the caller manually dials 911, the platform 101 can be configured to provide an augmented automatic emergency recognition function, which triggers an alarm to an emergency management personnel—e.g., a person is kidnapped or is held hostage and a detection device signals the emergency condition, or a person has been injured and is only able to hit an alerting device.

According to one embodiment, the platform 101 alerts devices 103b-103n based on their being found in the participant database 111 and being within the predetermined vicinity of mobile device 103a. The users of devices 103b-103n may decide to either send additional information about the event or decline to send more information. Those users declining to send additional information need no longer take any further actions and the device just sends metadata and stores the information in participant database 111. Those users sending additional information may choose what information to send and what other information to record which may be sent to the information database 113 including user name, contact information, videos, images, audio, etc. The participants sending information may also send information anonymously by masking their identifiers. Those devices, such as security cameras which cannot respond to queries may have predefined actions. Predefined actions for a security camera might include recording video over a certain time interval or only as long as the emergency is within its proximity, taking pictures at different time intervals or not do anything.

According to one embodiment, the platform 101 continues to alert devices within a predetermined vicinity of the notifying computing device 103a as the device 103a changes location and/or based on new participating devices entering the predetermined vicinity. In one embodiment, if the victim drops or otherwise loses the device used to notify the PSAP of the event, the PSAP may be able to determine or calculate the predetermined vicinity using location or other corroborating information provided by the assisting witness devices. For example, a child calls 911 during a kidnapping and drops his or her phone, the platform 101 can use real-time information provided by the participating witness devices to the PSAP to determine the child's location. That location is then used to determine set the boundaries for the predetermined vicinity. In other embodiments, the predetermined vicinity could be based on location of the closest participating device.

By way of example, in cases such as a hit and run of a pedestrian, a participating device within the car hitting the victim may be used to find the driver, the location of proximity may be changed to the car itself and follow its movements, thus participating devices may be those proximate to the vehicle along its route.

According to one embodiment, the event investigation platform 101 may notify assisting witnesses of potential dangerous situations to keep them out of the perpetrator's way. If the event involves the use of dangerous items (e.g., weapons) the PSAP may notify participants of the possible existence of such dangerous items or weapons and make sure witnesses stay back further.

According to other embodiments, the event investigation platform 101 may be used to track the metadata of a perpetrator's participating device. This is described in the hit and run example above. Also, in another example, should a robber be carrying a participating device such as a registered cell phone, the phone might be used to track his/her movements as well as continually notifying persons nearby to collect information about the robber. In other embodiments, the event investigation platform 101 may push the participating device to collect information by taking the device over in the background and recording sensor data with the robber's own device.

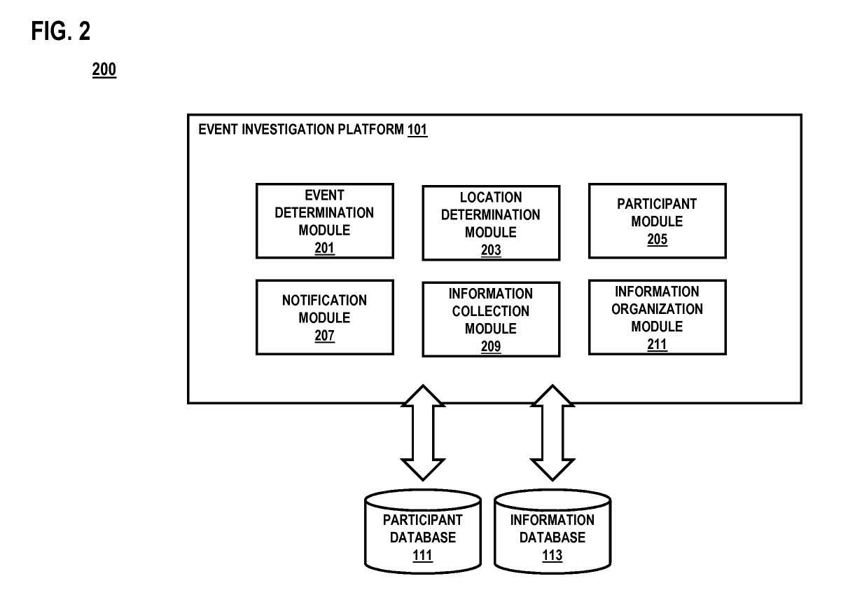

FIG. 2 is a diagram of a platform for investigating an event, according to various embodiments. The event investigation platform 101 includes various executable modules for performing one or more computing, data processing and network based instructions that in combination provide a means for enabling corroboration with the investigation of an emergency event to be used by authorities when investigating, responding to, or a combination thereof, an emergency event. Such modules can be implemented in hardware, firmware, software, or a combination thereof. By way of example, the investigation platform 101 may include an event determination module 201, location determination module 203, participant module 205, notification module 207, information collection module 209, and information organization module 211.

According to exemplary embodiments, notification module 207, and information collection module 209 may be configured to respectively generate/collect signals to/from computing device 103a utilizing any suitable bearer, including short messaging service (SMS) messages, enhanced messaging service (EMS) messages, multimedia messaging service (MMS) messages, electronic mail, files, or any other suitable bearer, as well as any suitable combination thereof. In particular implementations, these bearer mediums may include signals in various forms, including attention (AT) commands, menu traversal paths, function codes, voice data, dual-tone multi-frequency (DTMF) signals, scripts, strings, parameters, object variables, and the like. It is noted that these control signals can be used in lieu of “software code,” and therefore, may be directly integrated into the control logic of mobile device 103a, thereby requiring less processing and hence, less power. It is contemplated, however, that coded instructions may also be utilized.

In addition, the investigation platform 101 also accesses participant database 111 and information database 113 for maintaining event data already tagged subject to analysis. An information database 113 is also maintained for storing specific event information as provided by the various computing devices 103a-103n in communication with the event investigation platform 101. Also, information database 113 is also maintained for storing logs regarding the response actions taken by in response to a given notification. Still further, a participant database 111 is maintained for storing one or more user profile settings, privacy settings, subscription information, event management settings, privacy and data sharing policies and other data for regulating execution of the event investigation platform 101 relative to a given participant and/or device. It is noted that data from databases 113 may be further maintained or archived as part of a collective knowledge base. In certain embodiments, the knowledge base may be analyzed for refining and filtering information from the database. For example, the data of a kidnapping may have some similarities with the data of another kidnapping event that happened a few weeks before. The data collected from both of these events may be put together and may indicate a modus operandi of a kidnapper, thus helping the authorities investigating the kidnappings to solve the case quicker.

In one embodiment, the event determination module 201 determines whether a computing device is calling for a specific type of event, such as an emergency event e.g. crime in progress, person in need, etc. By way of example, the event determination module 201 receives a call for help through the 911 service or through another automated notification service. The event determination module 201 may determine the nature of the emergency through participant statement, location, time, context of a notice, type of automated service, or combination thereof.

Additionally, in one embodiment, the event determination module 201 may use the location determination module 203 to determine the location of the caller and associated event. The location of the event/caller may be used to find the closest emergency responders, closest participants or other devices/persons within a certain distance from the event. The location may also be used to determine potential participating devices used by perpetrators. The nature of the event may be used to further define or determine criteria for device/person notification (e.g., SMS, MMS, Push Notification, phone call, video call), or other actions by the PSAP.

In one embodiment, in order to determine participation, the participant module 205 is used in comparing the participant database 111 against devices/persons within the determined distance criteria of the event. The participant module 205 may also be used by participants to adjust various participant settings such as event notification settings, alarm intensity, auto recording parameters, etc.

In one embodiment, the notice is then sent to the participant/devices with the notification module 207 and the participant/device selects whether it wants to send additional information to the PSAP. The notification module 207 may then work with the information collection module 209 by sending the information to the information collection module 209 which stores the information in the participant database 111 if they don't want to include more information, and in the information database 113 if they do want to include more information for the authorities. The notification module 207 may also receive information as to whether the participant/device wants to send information anonymously or not. In the latter example, this enables the participant to maintain a level of anonymity and privacy when they share event data with authorities, emergency responders, community members or other contacts. It is also contemplated that if the participant does not send information anonymously, the participant may offer to be contacted by the authorities later to further help with the investigation.

By way of example, an anonymous participant may send information about an emergency event but specific types of information may be limited, such as allowing direct sensor recordings (e.g. video, image, audio, etc.) but participant notes on the event might not be allowed in case of fraud. In other embodiments, the anonymous participant may send any type of information about an emergency event.

In one embodiment, the information organization module 211 uses the information collection module 209 stored information by determining the method of organizing all the different types of data from different devices for the specified events to make a cohesive story for authorities to easily make use in resolving any events. For example, placing information from multiple devices 103a-103n in chronological order prioritizing clear video information above user text note information. The information organization module 211 may also prioritize information by specific participating devices over others such as a known perpetrator's participating device or victim's device simply based on collection of information from their perspective.

FIG. 3 is a flowchart of a process for instructing a witness device to submit information regarding the emergency event, according to one embodiment. For the purposes of illustration, the process is described with respect to the event investigation platform 101 operating in conjunction with the PSAP 107 (but as a separate entity). It is contemplated that the event investigation platform 101 can reside within the PSAP 107, or otherwise integrated.

In step 301, the event investigation platform 101 may receive notification of an event to initiate an information collection procedure to obtain information related to the event. By way of example, when a person dials, using mobile device 103a, an emergency number to the wireless network 115, the call is processed by a PSAP 107 either at within the wireless network 115, the telephony network 117, data network 121, or the service provider network 119. The PSAP 107 may communicate with the event investigation platform 101 to recognize the caller, along with recognizing the caller location in order to determine what participating devices may be in the vicinity of the caller, of a created emergency notification message as seen below. In some embodiments the event is an emergency event where a person notifying the event investigation platform 101 through a PSAP 107 will experience, has experienced or is experiencing an emergency e.g. robbery, accident, kidnapping, health problem, etc. The notification of the event may be determined by recognition of an emergency call within the emergency system above, automated alert or through notice to the PSAP by the notifier. The PSAP 107 or emergency responder receiving a call may then initiate the event investigation platform 101 to begin the procedure for collecting information from witnesses in the vicinity.

In one embodiment, the notifying mobile device 103a, after communicating with the event investigation platform 101, can define the nature of the event. The mobile device 103a may be used to define the event through text, voice or by using the situational circumstances of the mobile device. The initial information of the event as defined by the mobile device 103a may be used to define what and how information may be collected by selecting participating devices within a certain distance of the event or along a certain map pathway as described below. Which may then be obtained from the selected participating devices. These participating devices may then further define the event by adapting the initial event descripting with newly received knowledge about the emergency event, victim or perpetrator.

In step 303, the event investigation platform 101 may determine the location information associated with the event. By way of example the mobile phone may be configured to use SPS, GPS, A-FLT, WiFi, or by a user or participant stated location, or combinations thereof for determining the location of the emergency event. This location information is then used to determine an approximate location of the event which is later used to determine participants in the surrounding area. In some embodiments the location information may be continually updated, where the event may or may not have moved, in order to update the participants to the event investigation for receiving the best possible witness information. For example, the initial location of a robbery may be a bank, but the robbers may leave the bank and participants may be notified/used along the perpetrator's path of escape. The location may be acquired through conventional SPS technology, such as GPS technology, or any suitable navigational or location determination technology may be utilized, such as A-FLT, A-GPS, enhanced CELL-ID, WLAN positioning, user defined location, or participating party defined location, etc.

In step 305, the event investigation platform 101 may identify computing device(s) within proximity of the event based on the location information. In certain embodiments, the devices are found through scanning by provider towers, wireless frequency scanning, or network information. The scanned device(s) may then be correlated to the even. Some examples of potential scanned device(s) may include non-stationary and stationary devices including CPE, set-top boxes, desktop computers, wired telephone stations, security cameras, motion detectors, laptop computers, mobile phones, wireless portable devices (e.g., personal digital assistants (PDAs), tablets, etc. As devices in the vicinity of an event, the computing devices may be witnesses to the event. As such, knowledge of the witnesses and witness identification may be crucial in resolving the event or later prosecution of the event.

In step 307, the event investigation platform 101 may determine whether the identified computing device(s) are participating devices. In certain embodiments, the nearby participating devices are determined by comparing against a participant database 111 whether through hardware identification (e.g. MAC address), software identification (e.g. service set identifiers (SSID)), user defined naming convention, other device identifier, or combination thereof. In other embodiments, even if the computing device is found to not be a participating device, the PSAP may send the device a notice to register the device and help in the event investigation. Accordingly, in a first moment, neither the person in the midst of the event nor the participating/user need to be registered in order to respectively trigger the process by e.g. calling the PSAP or receive notification regarding an event. Participating devices are potential corroborating witnesses and need to be identified and notified of potential assistance in event information collection as soon as possible.

In step 309, the event investigation platform 101 may generate a message to instruct one or more participating devices to collect information related to the event. In some embodiments, the message generated may include those described in FIGS. 8A-8B below. In certain embodiments, the message is a notice which can be generated and pushed to nearby user devices based on the type of event. For example, in a robbery event, the notice may include information including the number of perpetrators, what was taken, armed/unarmed, exact location, time/date, etc. The message may be generated from the initial call/alert by the victim and updated based upon additional information received from participating devices as described below. The participating devices may include any number of computing devices (e.g. mobile phones, laptops, tablets, security cameras, etc.) that are nearby to the event. By way of example, the participant device may be a mobile device, which is configured to accept emergency broadcast messages.

The participating devices capable of receiving the alerts could be a mobile phone, tablet, laptop, security cameras, etc. For example, when a person dials an emergency number such as 911, a notice can be displayed by a tablet in the vicinity indicating that help is needed and/or for a user to collect information for the authorities. Participating devices will also be able to notify the PSAPs of non-participation and only send metadata, or send information anonymously.

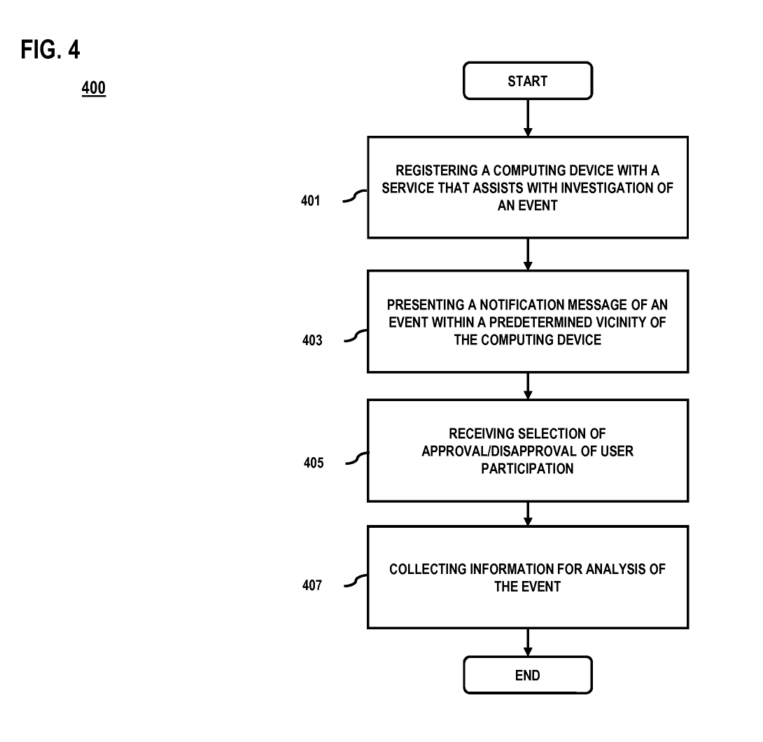

FIG. 4 is a flowchart of a process for providing event investigation through witness devices, according to one embodiment. For the purposes of illustration, the process is described with respect to the event investigation platform 101 operating in conjunction with computing devices that may or may not have been registered as participating devices. It is contemplated that the event investigation platform 101 can reside within the PSAP 107, or otherwise integrated.

In step 401, the event investigation platform 101 allows non-participants to register their computing devices 103a-103n so they are capable of assisting with the investigation of an event. The non-participant is a person/device that is not registered and has no information stored in the participant database 111. Thus the non-participant is may register his/her computing device and become a participant/user as a party potentially willing to assist in event investigations. In some embodiments, the registration may require the user to download an application used in the collection of event information. In other embodiments, the registration may not require any action by the participant whether an application is pushed to the participating device or not. In one embodiment, participants may be all devices using a certain service provider for access to the various networks 115-121. It is contemplated that even without participation the notification may be sent to a non-participant device after the event investigation platform 101 identifies the non-participating device as a device within the proximity of the event based on the location information of the event. This may be used to allow the non-participant to register and, subsequently, to immediately collect information of the specific event that is happening at that moment in the now-participating device's vicinity. It is also contemplated that the non-participating device may collect and submit information without registration.

Once the device is registered, in step 403, the event investigation platform 101 may present a notification to participating devices informing of an emergency event happening in the vicinity of the computing device. The notice sent to the participating device may include the information shown in FIGS. 8A-8B below. The notification may also include type of emergency, location of the event, appearance of the perpetrator, appearance of the victim, time/date, surrounding circumstances, or a combination thereof, or any other type of information regarding the event. The information sent with the notification to the participating device may also be adapted based on newly acquired information from other participating devices. The notification may also be used to warn bystanders of potential dangers. For example, non-participating and participating devices would be sent the notice to warn everyone in a vicinity of the event.

In step 405, the event investigation platform 101 is capable of receiving a selection of approval/disapproval of a computing device 103a-103n of a participant. The event investigation platform 101 may be notified by the participant of their interest in assisting the authorities with the event investigation through the approval. In one embodiment, if the participant disapproves his/her additional participation in information collection, the process ends and no other step is taken directly by the user. The approval/disapproval may be communicated to the PSAP 107. Although, metadata may still be collected from the device and sent to the PSAP 107, more information may only be collected under certain circumstances where authorities have the legal means to do so. In some examples, this may mean pushing collection of information in the background of a perpetrator's device.

In step 407, If the participant approves his/her assistance in information gathering for the investigation of an event through his/her computing device 103a-103n, event investigation platform 101 will collect metadata (e.g. time, location, device type, etc.), which may be analyzed and, subsequently sent to the PSAP 107. It is contemplated that the information collected and analyzed may also be specific information about the event, which may take the form of a text, audio, images, video, sensor data, etc., or a combination of any other specific event information. This information may include information directly taken from the participating device or information previously stored by the participating device. In one embodiment, information may be retrieved as described in FIGS. 9A-9B below.

In some embodiments, even with approval, the participant may send gathered information anonymously. This may remove another barrier to witnesses coming forward with key information about an emergency event since some persons may be afraid of reprisals by the alleged perpetrator(s). In one embodiment, anonymous information may only be directly collected by the participating device and not user stated knowledge in order to prevent potential fraudulent information from being included in the event information.

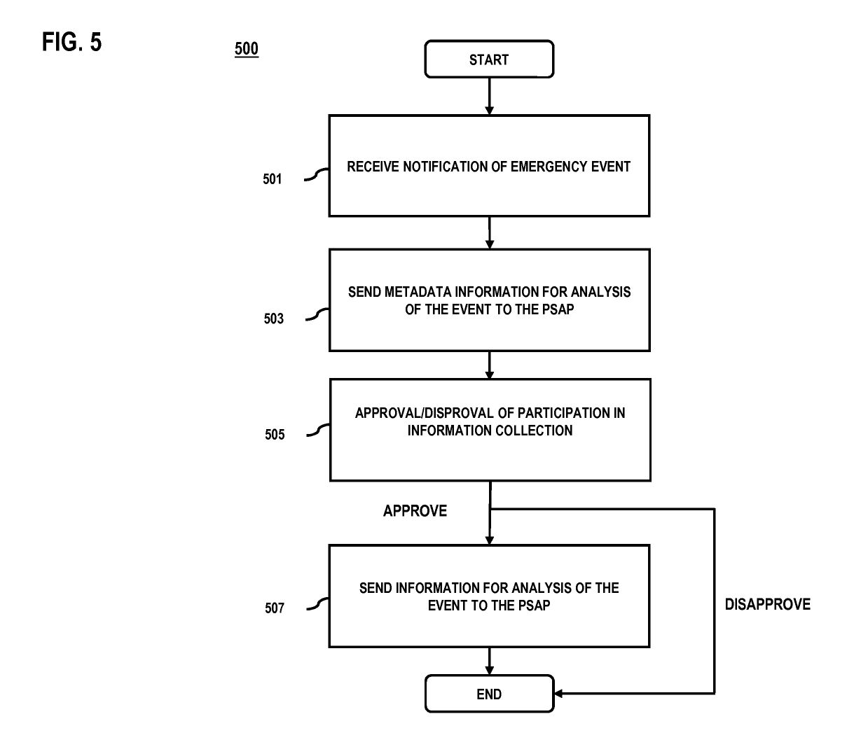

FIG. 5 is a flowchart of a process for submitting information regarding the emergency event, according to an exemplary embodiment. However, it is contemplated that the event investigation platform 101 can reside within the PSAP 107, or otherwise integrated.

In step 501, a computing device 103a-103n that is a participant device receives a notification of an emergency event from event investigation platform 101 about an emergency event in the vicinity of the computing device 103a-103n. The notification may be pushed to the participating devices, sent as text, voice, video, or image in order to provide the participant with enough information to respond to the emergency as an emergency responder or as an assistant in collecting information for the authorities. The notification may also include information to protect bystanders and keep them away from potential dangers. In one embodiment, the notification is described in FIGS. 8A-8B below.

In step 503, a computing device 103a-103n that is a participant receiving the notification of the emergency event from event investigation platform 101 automatically submits metadata information for analysis of the event to the PSAP 107. It is contemplated that according to the participant/user profile configurations, the metadata (e.g. time, location, device type, etc.) will only be submitted for analysis to the PSAP 107 after approval of participation in information collection, as per step 505 below. In other embodiments, the metadata is always submitted to the PSAP 107 by the participating device without user participant knowledge. In other embodiments, the participant may be queried about sending metadata to the PSAP 107.

In step 505, the event investigation platform 101 receives instructions submitted by the participant/user based on participant selection of approval or rejection of event information collection assistance. If the participant/user does not approve the participation in information collection, the process is interrupted and the participant may walk away from the event. In one embodiment, the participant may select approval or rejection through the notice as described in FIG. 8B below. In other embodiments, the participant automatically may be considered approved or not approved based on participant's previously selected preferences. This information may then be used to prepare the event investigation platform 101 to collect participant information.

In step 507, if the user/participant approves his/her participation in information collection, the information collected is sent for analysis to the PSAP 107. In one embodiment, collection is through user interfaces such as those described in FIGS. 9A-9B below. In one embodiment, the user/participant configures his/her profile to allow transmission of metadata (e.g. time, location, device type, etc.) only after his/her approval that the information can be sent. As previously mentioned, it is contemplated that event information (e.g., text, audio, images, video, etc.) may be submitted by the user as user selected previously stored information or automatically recorded and sent by the participating device. Additionally, the participant may be asked to direct the participating device toward the emergency event to gather relevant information. This direction may include pointing a camera toward the event in taking pictures or video of the event, moving closer to an event for a microphone to collect the sounds from the event, or other methods to better collect information about the emergency event.

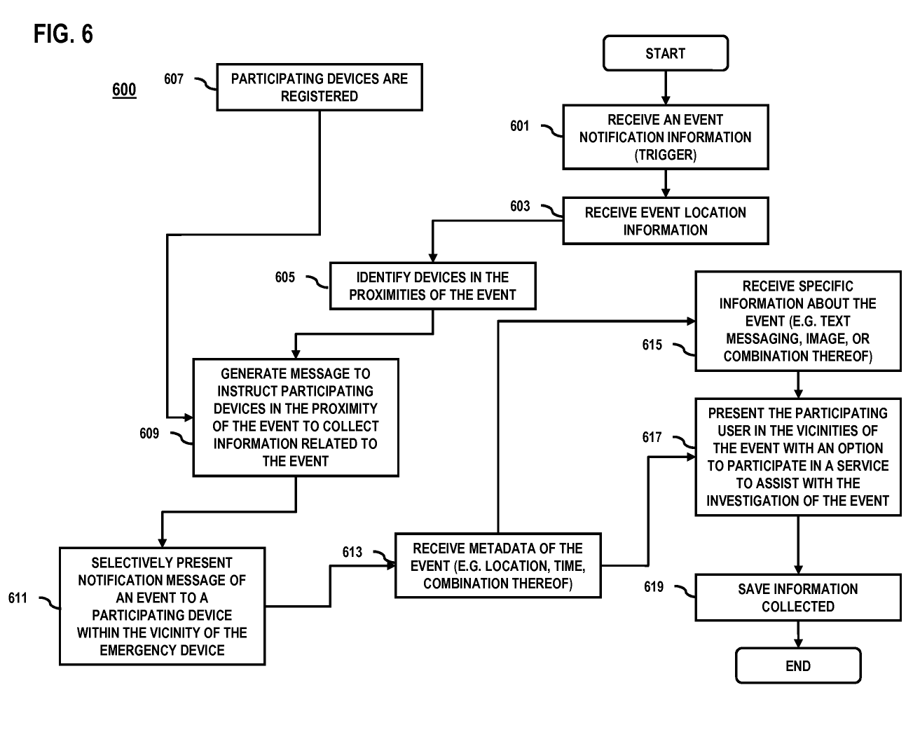

FIG. 6 is a flowchart of the process for enabling the acquisition of emergency event information from one or more participating devices, according to an exemplary embodiment. It is contemplated that the event investigation platform 101 can reside within the PSAP 107, or otherwise integrated.

In step 601 the event investigation platform 101 receives an event notification information from the PSAP 107, which triggers the process. The event information may also be received by the event investigation platform 101 through service provider network, by means of a SMS messages, EMS messages, MMS messages, electronic mail, files, or any other suitable bearer, automated alert system, as well as any suitable combination thereof. The event notification information may include type of emergency, location of the event, appearance of the perpetrator, appearance of the victim, or a combination thereof, among other types of information.

In step 603, the event investigation platform 101 receives an event location information, which may be acquired through conventional SPS technology, such as GPS technology; however, any suitable navigational or location determination technology may be utilized, such as A-FLT, A-GPS, enhanced CELL-ID, WLAN positioning, user defined location, or participating party defined location, etc.

In step 605, the participating devices in the proximity of the event are determined and/or selected based on the location information received by the investigation platform 101. The determination is based on finding all potential computing devices within a proximity of the emergency event and using that real-time list to compare against data from the participant database 111. The data may include MAC addresses for the device, SSIDs, or other compatible device identifier, or combination thereof. It is contemplated that a non-participating device may also be selected to assist in the investigation of the emergency event. In this case, the event investigation platform 101 presents the non-participating user with the option to register his/her devices step 607 to assist in the emergency event investigation. The option to register may be in form of a notification, which may include event notification information.

In step 607, computing devices 103a-103n may be registered in order to assist with the investigations of the emergency event. The computing device may be registered through a website or application, sending a device identifier, whether MAC address, SSID or similar identifier to be stored in the participant database 111. Once registered the computing device is then considered a participating device and may be sent further notifications of events in proximity to the participant automatically or other user defined factors. In other embodiments, the device may also be registered and correspond to specific users.

In step 609, the event investigation platform 101 generates a message instructing participating devices in the proximity of the event to collect information related to the event, which will cause the computing device 103a-103n to display the notification message of an event to the participating device within the vicinity of the emergency device to the participant/user, as per step 611. The generation of the message may include newly acquired information from participating devices or information notifying witnesses of potential dangers.

In step 611, the event investigation platform 101 presents the generated notification message to selected participants. The selected participants may generally be any proximate participants. In other embodiments, the participants may limit notification to certain factors such as location, time, event type or combination thereof and therefore not be selected by the PSAP for delivery of the message. The message may be sent by the PSAP 107 which may continue to send and receive new information which may be analyzed by the PSAP and used to adjust the generated message. In one embodiment, the adapted messages are sent continuously to newly selected participants within vicinity of the emergency event. In some embodiments, the emergency event locality may change over time.

In step 613, the event investigation platform 101 receives metadata of the event. As previously mentioned, it is contemplated that the metadata of the event (e.g. location, time, any other metadata of event, or a combination thereof) may be presented either before or after the participant/user approval of his/her participation in assisting the investigation of the event, which may depend on the participant/user's profile configurations. At this point, in addition to the metadata, the participant/user may opt to collect more specific information about the event or to proceed. If the participant/user opts not to collect more specific information, the next step is step 617.

If the participant/user opts to collect specific information about the event, in step 615, the participant/user may collect and submit this information; such information may be in the form of a text, image, audio, other specific means, or a combination thereof. This will permit the authorities investigation a certain emergency event e.g. to have access to videos recorded by a participant user while the event happens, or immediately after the event takes place.

In step 617, the event investigation platform 101 presents the participant/user with the option to participate in a service to assist with the investigation of the event. At this point the user may submit the information collected, anonymously or not. It is contemplated that the participant who submitted information about the event may elect to be available for further assistance in the investigation of the event, such as in a situation where the investigation authorities need to ask question to witnesses. In this case, the participant may make himself/herself available to respond to questions about the event that the authorities might have.

After the information about the event and/or about the participant user that witnessed the event is submitted, in step 619, the information may be saved so authorities can have access. As previously mentioned, in certain embodiments, the saved information may constitute a knowledge base which may be analyzed for helping authorities to discover facts about the event or events. For example, the data of a kidnapping may have some similarities with the data of another kidnapping event that happened a few weeks before. The data collected from both of these events may be put together and may indicate a modus operandi of a kidnapper, thus helping the authorities investigating the kidnappings to solve the case quicker. The information collected will also be stored related to the participant and may later be used to be verified by the authorities upon questioning of the participant.

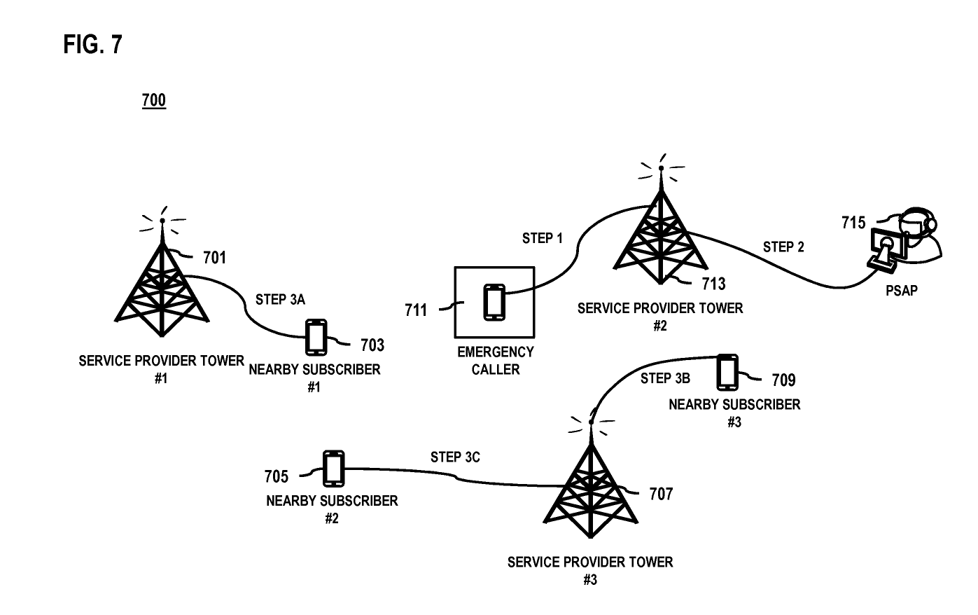

FIG. 7 is a diagram depicting an interaction between towers, computing devices, public-safety answering point, and participating devices in various locations, according to one embodiment. Step 1 shows an emergency caller 711 connecting to a service provider tower 713, which subsequently connects the emergency caller to the PSAP 715, as demonstrated in step 2. This illustrates, e.g., a 911 call to inform authorities of an emergency event.

Step 3A illustrates a service provider tower 701 connecting to a nearby subscriber of the service 703. At this point, the a participant/user is located, wherein the user may be located can be found through conventional SPS technology, such as GPS technology, or any suitable navigational or location determination technology, such as A-FLT, A-GPS, enhanced CELL-ID, WLAN positioning, user defined location, or participating party defined location, etc., or any combination of spatial positioning information technology.

In Step 3B and Step 3C the nearby subscribers 709 and 705 are selected to participate in assisting the investigation of the emergency event. It is contemplated that not all the users located within the vicinity of the emergency event are selected. The users may be selected through one or more selection criteria, such as proximity, time of the day, previous participation, and/or any other such criteria.

FIGS. 8A and 8B are diagrams of a user interface for receiving an emergency event notification and approving participation in assisting with the investigation of the emergency event, according to various embodiments. FIG. 8A is a computing device 103a-103n which may, in some embodiments, be a cellular phone 801. The notification generated in step 609 of FIG. 6 is presented to the participant as displayed in the notification 803. In one embodiment, the notification includes a large emergency message filling the participating device's screen stating what is known about the emergency event and that it is occurring nearby. The user may then use the ‘OK’ button 805 to notify the PSAP 107 that it received the notification. Once that has occurred, in one embodiment, the participant may then use any of the computing device functions such as returning to what they were doing on the device with the back button 807, going to the home screen with the home button 809, searching with the search button 811, or any of the secondary functions of those buttons. In another embodiment, shown in FIG. 8B the participant is sent an approval message 813 with the two choices of assisting in the investigation of the event through approving 817 or doing nothing through rejection 815.

Notification 803, that includes information about the event, may provide location information; for example, the following street address is shown: “1222 ABHYASI ROAD.” Further, the notification 803 can show the distance of the site of the event—e.g., 200 feet. Depending on the applications and functional capabilities of the cellular phone 801, optional buttons can be provided. For example, a button may permit the user to acquire directions to the site. Furthermore, the participant can be presented with the option to connect to the PSAP 107. In such an arrangement, the participant can provide critical information to the PSAP 107 about a perpetrator while the operator is also able to interact with the participant. This information can be relayed to the emergency responders to permit them to more effectively treat the participant. This allows the operator to e.g. instruct the participant to distance himself/herself from the perpetrator because is too risky to attempt to collect more information.

FIGS. 9A and 9B are diagrams of a user interface for submitting information about an emergency event and collecting more specific information about the emergency event according to various embodiments. In one embodiment, FIG. 9A shows the participating device 901 and a user interface used in collecting information from the assisting participant. The user is presented with a message 903 to submit information from a stored location which may be defined by the participant in input window 905. The participant is also presented with the option to cancel submission 907 or submit 909 the stated information from the stored location. Buttons 911, 913 and 915 may be used in searching the participating device for the location of the information in its storage. In other embodiments, the participant may select a file directly from the device storage and send directly to the PSAP 107 through a participant application.

In another embodiment, FIG. 9B shows the user interface of the participating device with a message 917 stating real-time collection of various forms of information such as audio 919, video 923, written text notes from the user 921, or image/picture 925 as allowed on such a participating device. Certain computing devices may lack video recording capabilities and as such the option for video recording 923 would not be displayed. In other embodiments, the real-time information collection may send the recording directly to the PSAP without storing in the participant's device. In other embodiments, the participant may select more than one real-time method of information collection. In other embodiments, the text note may be typed or created by a combination of typing and/or voice-to-text.

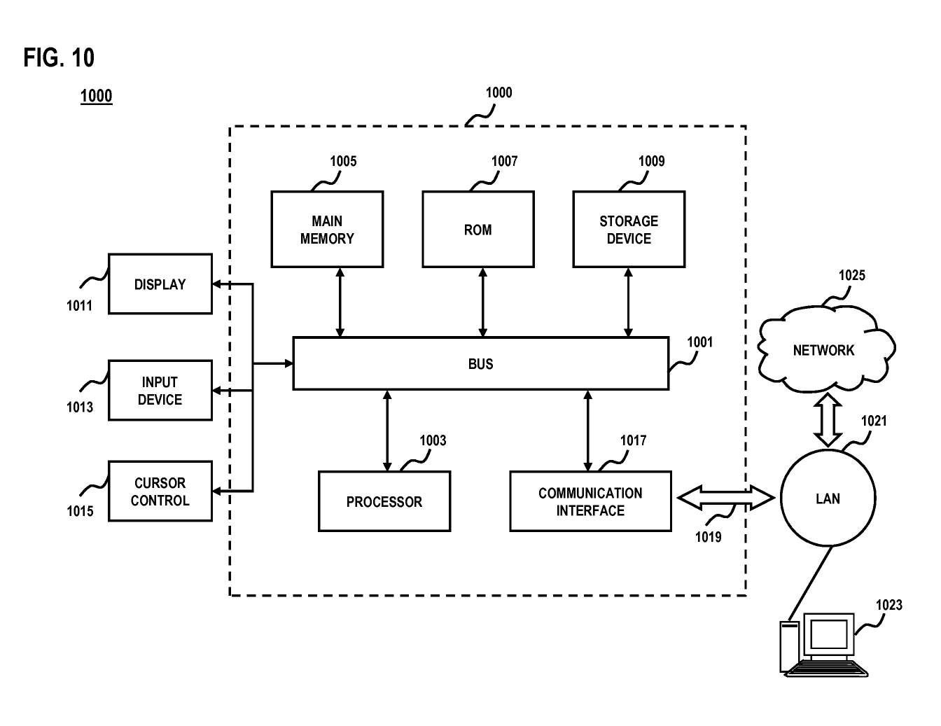

FIG. 10 illustrates computing hardware (e.g., computer system) upon which these embodiments can be implemented. The computer system 1000 includes a bus 1001 or other communication mechanism for communicating information and a processor 1003 coupled to the bus 1001 for processing information. The computer system 1000 also includes main memory 1005, such as random access memory (RAM) or other dynamic storage device, coupled to the bus 1001 for storing information and instructions (computer program code) to be executed by the processor 1003. Main memory 1005 also can be used for storing temporary variables or other intermediate information during execution of instructions by the processor 1003. The computer system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computer system 1000 may be coupled via the bus 1001 to a display 1031, such as a cathode ray tube (CRT), liquid crystal display, active matrix display, or plasma display, for displaying information to a computer user. An input device 1033, such as a keyboard including alphanumeric and other keys, is coupled to the bus 1001 for communicating information and command selections to the processor 1003. Another type of user input device is a cursor control 1035, such as a mouse, a trackball, or cursor direction keys, for communicating direction information and command selections to the processor 1003 and for controlling cursor movement on the display 1031.

According to certain embodiments, the processes described herein are performed by the computer system 1000, in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the invention. Thus, embodiments of the invention are not limited to any specific combination of hardware circuitry and software.

The computer system 1000 also includes a communication interface 71037 coupled to bus 1001. The communication interface 1037 provides a two-way data communication coupling to a network link 1039 connected to a local network 1021. For example, the communication interface 1037 may be a digital subscriber line (DSL) card or modem, an integrated services digital network (ISDN) card, a cable modem, a telephone modem, or any other communication interface to provide a data communication connection to a corresponding type of communication line. As another example, communication interface 1037 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1037 sends and receives electrical, electromagnetic, or optical signals that carry digital data streams representing various types of information. Further, the communication interface 1037 can include peripheral interface devices, such as a Universal Serial Bus (USB) interface, a PCMCIA (Personal Computer Memory Card International Association) interface, etc. Although a single communication interface 1037 is depicted in FIG. 6, multiple communication interfaces can also be employed.

The network link 1039 typically provides data communication through one or more networks to other data devices. For example, the network link 1039 may provide a connection through local network 1021 to a host computer 1023, which has connectivity to a network 1025 (e.g. a wide area network (WAN) or the global packet data communication network now commonly referred to as the “Internet”) or to data equipment operated by a service provider. The local network 1021 and the network 1025 both use electrical, electromagnetic, or optical signals to convey information and instructions. The signals through the various networks and the signals on the network link 1039 and through the communication interface 1037, which communicate digital data with the computer system 1000, are exemplary forms of carrier waves bearing the information and instructions.

The computer system 1000 can send messages and receive data, including program code, through the network(s), the network link 1039, and the communication interface 1037. In the Internet example, a server (not shown) might transmit requested code belonging to an application program for implementing an embodiment of the invention through the network 1025, the local network 1021 and the communication interface 1037. The processor 1003 may execute the transmitted code while being received and/or store the code in the storage device 1009, or other non-volatile storage for later execution. In this manner, the computer system 1000 may obtain application code in the form of a carrier wave.

The term “computer-readable medium” as used herein refers to any medium that participates in providing instructions to the processor 1003 for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

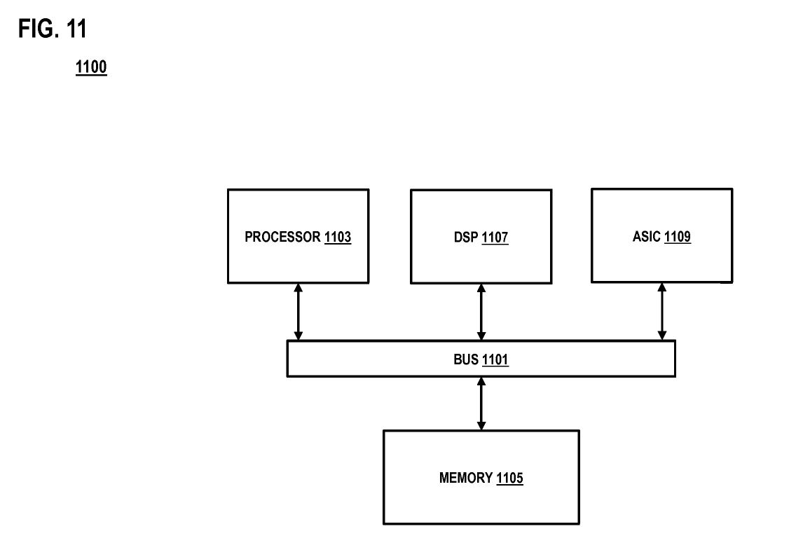

FIG. 11 illustrates a chip set or chip 1100 upon which an embodiment of the invention may be implemented. Chip set 1100 is programmed to enable event notifications to be directed to one or more participating devices based on the event used for collecting evidence regarding the event which includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of enabling event notifications to be directed to one or more contacts based on the acquiring of common event data by one or more wireless devices.

In one embodiment, the chip set or chip 1100 includes a communication mechanism such as a bus 1103 for passing information among the components of the chip set 1100. A processor 1103 has connectivity to the bus 1103 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1103 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1101. A DSP 1107 typically is configured to process real-world signals (e.g., sound) in real time independently of the processor 1103. Similarly, an ASIC 1101 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1103. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to enable event notifications to be directed to one or more contacts based on the acquiring of common event data by one or more wireless devices. The memory 1105 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving notification of an event to initiate an information collection procedure to obtain information related to the event;
determining location information associated with the event;
identifying one or more computing devices within proximity of the event based on the location information;
determining whether the identified one or more computing devices are participating devices; and
generating a message to instruct one or more of the participating devices to collect information related to the event.

2. The method according to claim 1, further comprising:
transmitting the message to the one or more of the participating devices to collect the information; and
receiving the information for analysis of the event.

3. The method according to claim 2, wherein the information includes only metadata that includes location data, timing data, or a combination thereof.

4. The method according to claim 1, wherein the information is submitted anonymously to mask identity of the one or more participating devices or of user accounts associated with the one or more participating devices.

5. The method according to claim 1, further comprising:
selecting the one or more participating devices according to one or more selection criteria, wherein only the selected participating devices are instructed to collect the information related to the event.

6. The method according to claim 1, further comprising:
communicating with a public safety answering point (PSAP) to receive the notification.

7. The method according to claim 1, further comprising:
specifying a collection time interval for the collection of the information from the participating devices; and
selectively notifying the participating devices that no more information will be accepted after the collection time interval lapses.

8. The method according to claim 1, wherein the one or more computing devices include a mobile phone, a tablet, a laptop, a set-top box, or a combination thereof, and the information includes text, messaging data, sound recording, an image, a video, or a combination thereof.

9. The method according to claim 1, wherein the one or more computing devices submit the information via a local application or a web interface, and the transmitted message includes a custom link for the web interface.

10. A method comprising:
registering a computing device with a service that assists with investigation of an event; and
presenting, via a graphical user interface (GUI) executed by a computing device, a notification message of an event within a predetermined vicinity of the computing device, wherein the GUI includes,
a first area for displaying of the notification message,
a second area for inputting approval to participate in a service to assist with investigation of the event, and
a third area for submitting information collected by the computing device, wherein the information is relevant to the event.

11. The method according to claim 10, further comprising:
transmitting the information for analysis of the event to a system configured to provide the service.

12. The method according to claim 11, wherein the information includes only metadata that includes location data, timing data, or a combination thereof.

13. The method according to claim 10, wherein the GUI further includes, a fourth area to specify that the information is to be submitted anonymously to mask identity of the computing device or of user account associated with the computing device.

14. The method according to claim 10, wherein the information includes text, messaging data, an image, a video, or a combination thereof.

15. An apparatus comprising a processor configured to:
receive notification of an event to initiate an information collection procedure to obtain information related to the event;
determine location information associated with the event;
identify one or more computing devices within proximity of the event based on the location information;
determine whether the identified one or more computing devices are participating devices; and
generate a message to instruct one or more of the participating devices to collect information related to the event.

16. The apparatus according to claim 15, wherein the apparatus is further configured to:
transmit the message to the one or more of the participating devices to collect the information; and
receive the information for analysis of the event.

17. The apparatus according to claim 16, wherein the information includes only metadata that includes location data, timing data, or a combination thereof.

18. The apparatus according to claim 15, wherein the information is submitted anonymously to mask identity of the one or more participating devices or of user accounts associated with the one or more participating devices.

19. The apparatus according to claim 15, wherein the apparatus is further configured to:
select the one or more participating devices according to one or more selection criteria, wherein only the selected participating devices are instructed to collect the information related to the event.

20. The apparatus according to claim 15, wherein the apparatus is further configured to:
communicate with a public safety answering point (PSAP) to receive the notification.

21. The apparatus according to claim 15, wherein the apparatus is further configured to:
specify a collection time interval for the collection of the information from the participating devices; and
selectively notify the participating devices that no more information will be accepted after the collection time interval lapses.

22. The apparatus according to claim 15, wherein the one or more computing devices include a mobile phone, a tablet, a laptop, a set-top box, or a combination thereof, and the information includes text, messaging data, sound recording, an image, a video, or a combination thereof.

23. The apparatus according to claim 15, wherein the one or more computing devices submit the information via a local application or a web interface, and the transmitted message includes a custom link for the web interface.

24. An apparatus comprising a processor configured to:
register a computing device with a service that assists with investigation of an event; and
present, via a graphical user interface (GUI) executed by a computing device, a notification message of an event within a predetermined vicinity of the computing device, wherein the GUI includes,
a first area for displaying of the notification message,
a second area for inputting approval to participate in a service to assist with investigation of the event, and
a third area for submitting information collected by the computing device, wherein the information is relevant to the event.

25. The apparatus according to claim 24, wherein the apparatus is further configured to:
transmit the information for analysis of the event to a system configured to provide the service.

26. The apparatus according to claim 25, wherein the information includes only metadata that includes location data, timing data, or a combination thereof.

27. The apparatus according to claim 24, wherein the GUI further includes, a fourth area to specify that the information is to be submitted anonymously to mask identity of the computing device or of user account associated with the computing device.

28. The apparatus according to claim 24, wherein the information includes text, messaging data, an image, a video, or a combination thereof.
